(19) United States
(12) Patent Application Publication
(10) Pub. No.: US 2019/0047342 A1
(43) Pub. Date: Feb. 14, 2019

(54) VERTICAL TAKEOFF AND LANDING TRANSPORTATION SYSTEM

(71) Applicant: Terrafugia, Inc., Woburn, MA (US)

(72) Inventor: Carl C. Dietrich, Petaluma, CA (US)

(73) Assignee: Terrafugia, Inc.

(21) Appl. No.: 16/058,960

(22) Filed: Aug. 8, 2018

Related U.S. Application Data
(60) Provisional application No. 62/542,545, filed on Aug. 8, 2017.
(60) Provisional application No. 62/634,772, filed on Feb. 23, 2018.

(51) Int. Cl. B60F 5/02; B64C 37/00; B64C 29/00; B62D 63/02; B64D 17/80; G06Q 50/28

(52) U.S. Cl. CPC B60F 5/02; B64C 37/00; G06Q 50/28; B62D 63/025; B64D 17/80; B64C 29/0025

(57) ABSTRACT

An integrated transportation system with vertical take-off and landing capabilities utilizes multiple common ground, pod, and flight components to facilitate efficient vertiport operations. Automated system operations, enable individuals and cargo routing between destinations in congested urban environments, as well as in remote locations selectively using the integrated ground vehicles and flight vehicles to deliver the payload pod to the destination.

### RELATED APPLICATIONS

This Application claims priority to U.S. Provisional Application No. 62/542,545, filed Aug. 8, 2017, and U.S. Provisional Application No. 62/634,772, filed Feb. 23, 2018, which are incorporated herein by reference.

### BACKGROUND

There is significant interest in the use of high specific power electric motors to enable quiet and clean Vertical Take Off and Landing (VTOL) flight in and around urban centers for the efficient transportation of people and goods—avoiding traffic congestion on the ground. Over the past few years, more than a dozen companies, including major OEMs around the world, have launched programs to develop these electric VTOL (eVTOL) aircraft. The industry has successfully identified some of the major barriers to the development of a healthy eVTOL market including battery technology, noise, operating costs, safety, and the current regulations that pertain to flight in and around cities. Many of the concepts being pursued by the companies in the developing sector are designed to address these barriers to the emergence of this new industry.

### SUMMARY

Embodiments of the disclosure address the scalability problems of solutions to these barriers and include a complete door-to-door transportation system that can be scaled to high operational rates, thereby maximizing the market potential.

A key realization that catalyzed embodiments of the disclosure is acknowledgement of the realistic bottleneck in any urban VTOL transportation system: vertiport operations.

The number of realistic vertical takeoff and landing areas (vertiports) in any major metropolitan area is limited in the foreseeable future by the presence of existing infrastructure and obstacles that may pose a safety risk to practical VTOL flight. Most cities have dozens to at most a few hundred safe areas where VTOL operations may be conducted (per guidance from the FAA and other regulatory authorities). Of those potential safe vertiport locations, many of them may be blocked by local ordinances that may prohibit such VTOL operations due to noise, privacy, and safety concerns.

As a consequence of this reality, no matter how large the market demand may be for personal flight over traffic congestion in and out of a city, the realistic market may be limited by the maximum rate of VTOL operations that can be conducted from the relatively small number of approved vertiport locations in the foreseeable future.

In order to maximize the rate of flight operations at vertiports (and thereby maximize the potential market for such vehicles), it is important to reduce the amount of time each flight occupies a vertipad, and reduce the parking area required for flight vehicles at each vertiport so that the number of vertipads per vertiport can be increased.

Some solutions typically require flight vehicle loading and charging to be conducted at the vertiport. This requires flight vehicle parking at the vertiport, which is not a good use of the limited space at these locations. In addition, loading and charging at the vertiport introduces variability in the bottleneck of the system that may be highly undesirable at scale operations. The one potential exception is the Airbus Pop.Up concept, which has the theoretical flexibility to allow loading and charging away from a traditional vertiport. However, the Pop.Up concept has significant practical operational deficiencies which embodiments of this disclosure overcome in a novel manner. The improvements provided by embodiments of the disclosure fundamentally and radically facilitate the expansion of this emerging market. For example, the other systems require a ground vehicle to be present to land on to be able to transfer any pod or cargo. Here, however, various embodiments contemplate that the flight vehicle may lower the pod on to the ground vehicle, the ground vehicle may rise up to meet the pod, the ground vehicle and air vehicle may be complementarily configured such that no adjustment between either is needed, the mounting system may allow for a variable or adjustable engagement height, or combinations thereof, to allow transfer of the pod.

### BRIEF DESCRIPTION OF THE FIGURES

FIG. 1 is a perspective view of an illustrative flight vehicle with an illustrative payload pod, in accordance with an embodiment of the disclosure.

FIG. 2 is a side cutaway view of the illustrative flight vehicle and illustrative payload pod of FIG. 1, in accordance with an embodiment of the disclosure.

FIG. 3 is a top cutaway view of the illustrative flight vehicle and illustrative payload pod of FIG. 1, in accordance with an embodiment of the disclosure.

FIG. 4 is a front cutaway view of the illustrative flight vehicle and illustrative payload pod of FIG. 1, in accordance with an embodiment of the disclosure.

FIG. 5 is a cutaway view of a pod, in accordance with an embodiment of the disclosure.

FIG. 6 is a perspective cutaway view of a pod, in accordance with an embodiment of the disclosure.

FIGS. 7-9 are perspective views of illustrative ground transportation systems, in accordance with an embodiment of the disclosure.

FIG. 10 is a illustrative operational environment, in accordance with an embodiment of the disclosure.

FIG. 11 is a flowchart of an illustrative method, in accordance with an embodiment of the disclosure.

### DETAILED DESCRIPTION

Embodiments of the disclosure include a transportation system having three key components: a flight vehicle, a passenger/cargo pod, and a ground vehicle.

The passenger/cargo pod (the Pod) is capable of docking with either the ground vehicle (mated to the bottom surface of the Pod) or the flight vehicle (mated to the top surface of the Pod).

The ground vehicle provides propulsion for the Pod on the ground—allowing car-like operations for loading/unloading and true door-to-door service. The ground vehicle also enables the docking and undocking of the Pod after the flight vehicle has landed.

The flight vehicle is adapted to receive the Pod. The flight vehicle has propellers that can be used for VTOL and cruise flight, and a wing to improve the cruise Lift-to-Drag ratio (L/D) when compared to other systems. Additionally or alternatively, various embodiments contemplate that the Pod may contain some, a majority, or all of the energy storage systems for the flight vehicle. For example, the flight vehicle may be coupled to the Pod and configured to receive power from the Pod.

In a typical operation, a potential user may input his desired destination on an app on his smartphone. A cloud-based software system may automatically route a ground vehicle with a Pod to an agreed upon location. The driving operation may be autonomous, or a professional vehicle operator may drive the vehicle. In some embodiments, during the driving trip to the vertiport, the ground unit may transfer energy to the Pod's energy storage system. Vehicle status may be continuously monitored by the cloud-based software. Other customers that wish to travel to a vertiport near the desired destination may also be picked up on the way to the vertiport, in a carpool like operation where routing is optimized by the control system software. In this way, the cost to the end user can be minimized through cost sharing. Additionally or alternatively, municipalities could use various embodiments as public transportation, wherein the ground vehicle follows regularly scheduled shuttle routes like a mini-bus.

After all passengers are picked up, the vehicle may drive to the nearest vertiport. The people do not get out of the Pod; this reduces the variable time of the operations at the vertiport while simultaneously improving operational safety on the vertipad. The ground vehicle may automatically position itself under the flight vehicle, and the Pod may be docked to the flight vehicle, for example, by the Pod being raised into the mating position with the flight vehicle by a lift built into the ground vehicle. The flight vehicle may the lock into the pod. The electrical connections from the Pod to the flight vehicle may be automatically checked, and the ground vehicle unlocked from the pod and driven away from the flight vehicle. Various embodiments contemplate that the ground vehicle may be controlled remotely or locally by an operator. The flight plan may be automatically loaded from the cloud. The operator may confirm that the area is clear and that the passengers are ready to depart, and the operator may then give a command to the vehicle to take-off.

The vehicle may then autonomously execute the flight. On route, the software system may constantly monitor the state of the vehicle systems and advise the operator if any changes to the planned route are recommended. As the vehicle approaches the landing vertiport, the operator can abort the landing if an unsafe condition exists, but nominally, the vehicle may land itself at the destination vertiport. Another ground vehicle may position itself under the Pod as soon as the flight vehicle lands. The ride height adjustable suspension on the ground vehicle may extend up and lock into the Pod. The electrical connections may be automatically checked, and the locks to the flight vehicle may be released. The ground vehicle may lower the Pod and drive off the vertiport—dropping the passengers at their desired destinations as guided by the cloud-based software and then picking up new passengers for another trip. Additionally or alternatively, various embodiments contemplate that the ground vehicle may transfer energy to the Pod during the trip.

The ground vehicle and the Pod can be either all electric (100% battery powered) or hybrid powered for extended range missions. There may be long range hybrid FV and short range all-electric FVs.

Unlike the Pop.Up concept, in embodiments of this disclosure all docking and un-docking is conducted while the flight vehicle is on the ground—dramatically simplifying the procedure from a technical perspective, and allowing the operation to be conducted in weather conditions that may otherwise prevent the Pop.Up from conducting a successful docking with the ground vehicle. The docking is enabled by an autonomous parking and lift system which, in one discussed embodiment, is ride-height adjustable suspension located in the ground vehicle. However, other embodiments contemplate locating a lift/drop system in the flight vehicle or the Pod itself, or combinations thereof.

In addition, embodiments of this disclosure use a fixed wing to provide lift to the flight vehicle when cruising. The use of a fixed wing instead of four ducted fans during cruise may allow the range of the flight vehicle in accordance with embodiments of this disclosure to be three to four times the range of the Pop.Up vehicle for a given battery technology. Because embodiments of the present disclosure typically require much less power to cruise and much less power to control the flight, they inherently have more safe emergency landing options in the event of a partial or complete power failure during flight.

Various embodiments of the present disclosure have batteries only in the Pod and the ground vehicle. This allows seamless swapping/upgrading of battery technology without removing the flight vehicle from the flight line. These Pod swaps may be recommended by the cloud-based software that constantly monitors battery and vehicle performance.

The flight vehicle may be the most expensive part of the transportation system, so increasing the utilization of the most expensive part of the asset is important for maximizing the profit from the system.

With embodiments of this disclosure, the time a flight vehicle (FV) spends on the ground can be reduced and the variability of time on the ground can be dramatically reduced, thereby maximizing the potential rate of revenue from the transportation system. In addition, the ground-based docking of vehicle components allows the use of the transportation system in more and different weather conditions than any system that requires precision docking from the air—maximizing system availability.

### An Illustrative Embodiment

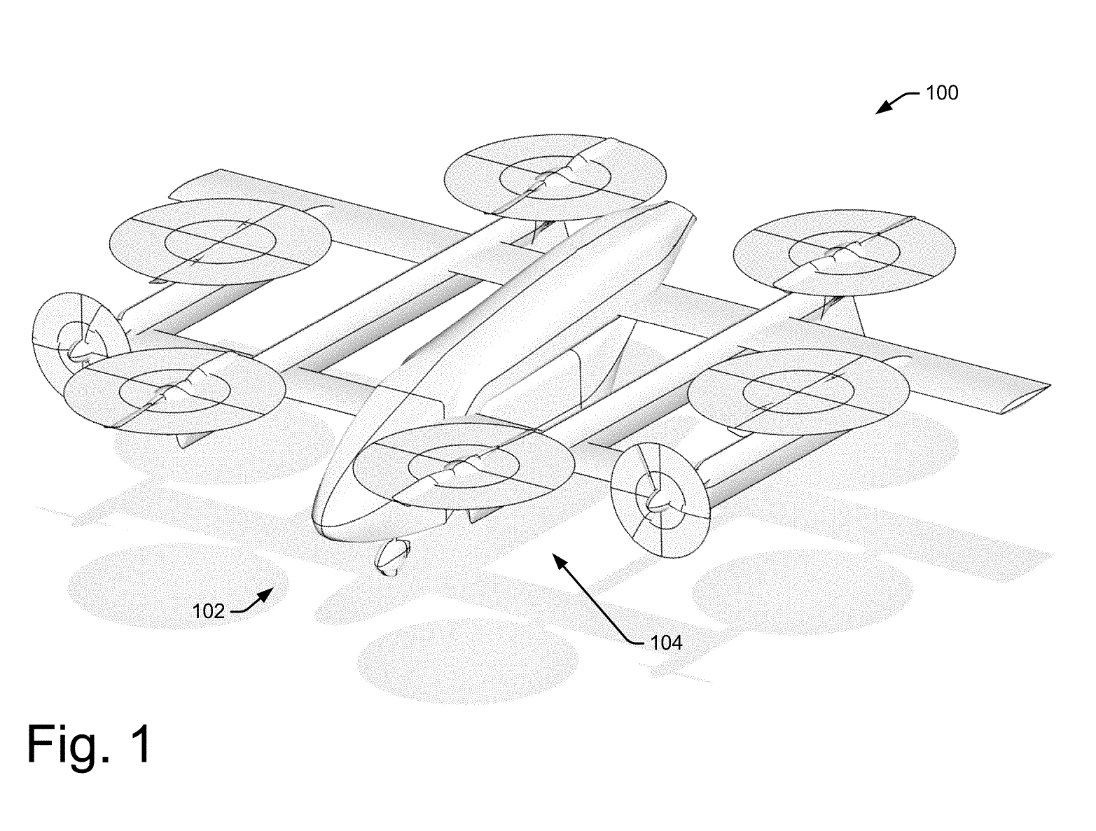

FIG. 1 shows a portion of an illustrative embodiment of a flight system 100. For example, FIG. 1 shows a flight vehicle 102 coupled to a Pod 104.

Additionally or alternatively, one illustrative embodiment of the flight vehicle has no fluids, no retractable landing gear, only six flight control surfaces actuated via redundant actuators, and eight propulsion motors. This design reduces the cost and time of inspections that are required to maintain a flight vehicle in an airworthy condition. The wing may be optimized for high speed cruise flight with little compromise for stall speed and landing performance since landing is be accomplished by the vertical lift system. A center module between the lift fans may include the pilot/operator, a hybrid power generator, a fuel tank, a full vehicle parachute system, the necessary connections to the Pod, and a redundant air data sensor package. The outboard booms will contain the electrical energy storage system (e.g., batteries), and provide structure to transfer loads from the lifting fans to the wings.

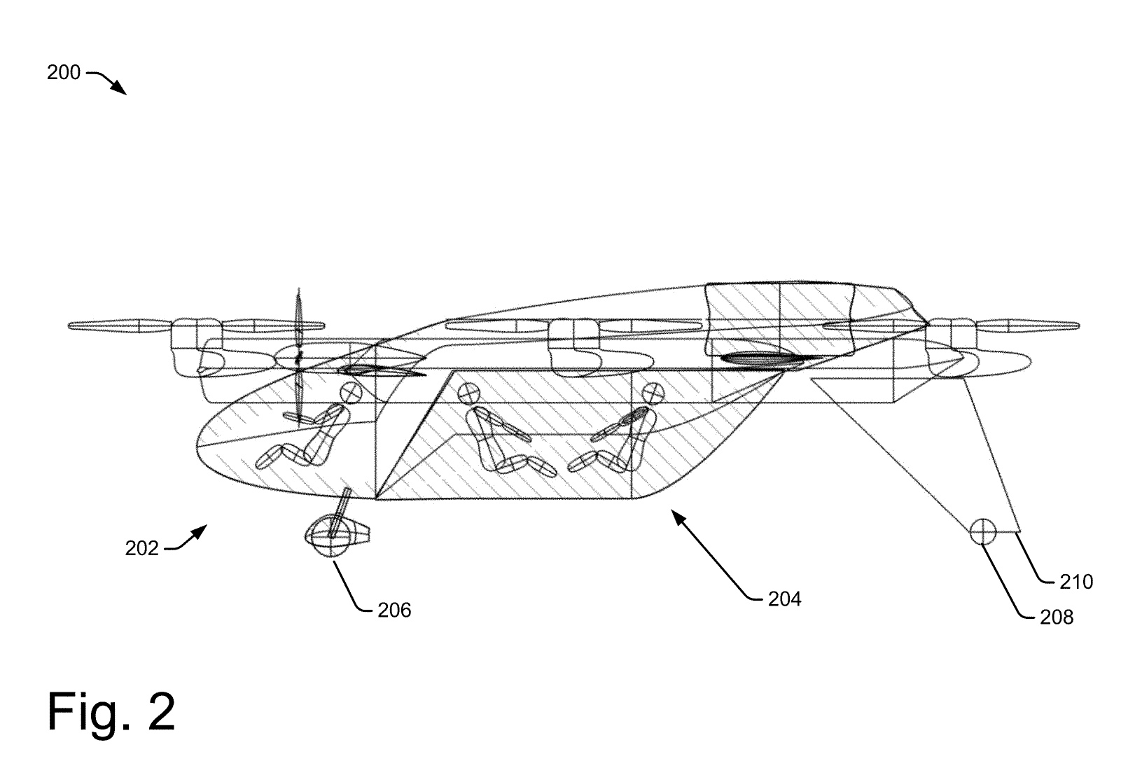

FIG. 2 shows a cutaway view of a flight system 200. For example, the flight system may comprise a flight vehicle 202 coupled to a Pod 204. Here, for example the Pod 204 is coupled to a mating surface of the flight vehicle 202. Additionally or alternatively, FIG. 2 shows a flight system configuration where the flight vehicle 202 has landing gear 206 and 208 to elevate Pod 204 when the flight system has landed. Additionally or alternatively, the landing gear 208 may be coupled to a vertical stabilizer 210 of flight vehicle 202. Various embodiments contemplate that vertical stabilizers 210 may be spaced sufficiently apart from each other to allow sufficient stability of the flight system when landed on landing gear 208. Additionally or alternatively, the vertical stabilizers 210 may also be sufficiently spaced to allow access to the Pod 204 by a ground vehicle (not pictured).

In an embodiment, to ensure reliability of the system, the FV and/or Pod may have multiple independent power buses. Each energy storage system may connected to each power bus, and each motor and may draw power from each bus.

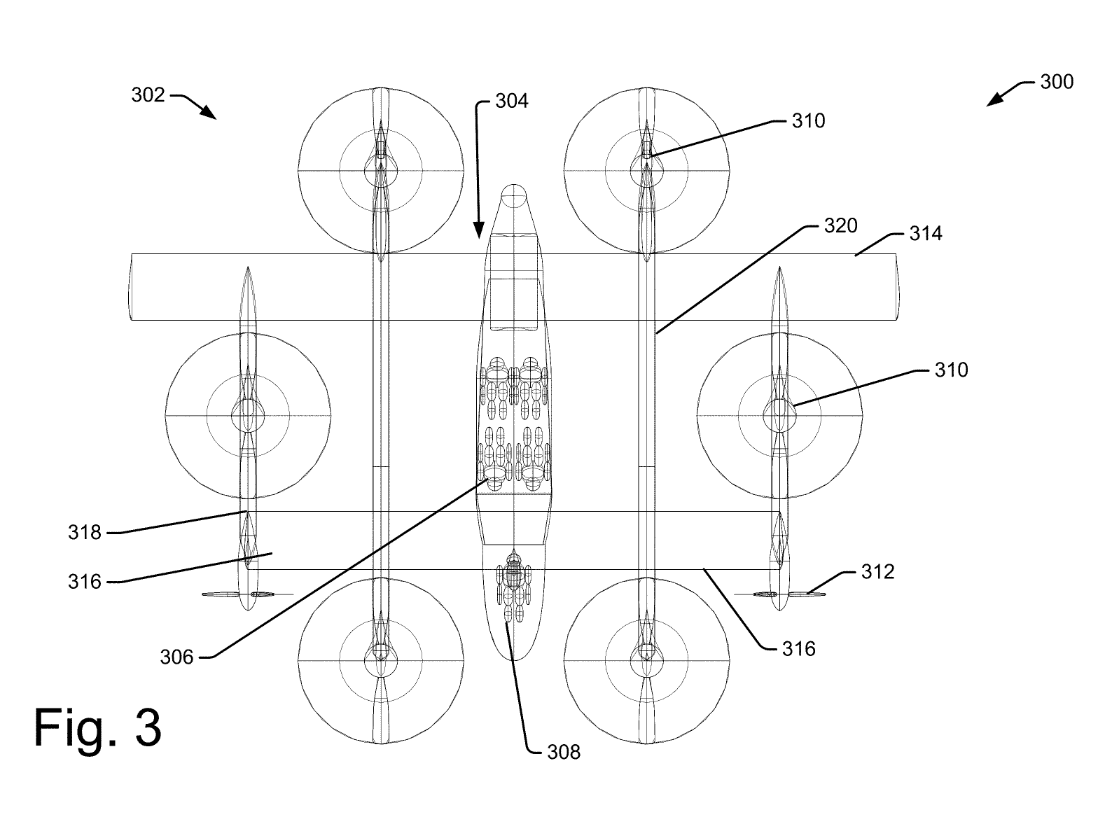

FIG. 3 shows a view from the top of a flight system 300. For example, flight system 300 may comprise a flight vehicle 302 coupled to a Pod 304. Here, FIG. 3 shows a cutaway view where passengers 306 may be seen in the Pod 304. Additionally or alternatively, various embodiments contemplate the flight vehicle is controlled by a controller 308, for example, a pilot. Additionally or alternatively, various embodiments contemplate that the flight vehicle 302 comprises eight propulsion motors 310 and 312. This design reduces the cost and time of inspections that are required to maintain a flight vehicle in an airworthy condition. The wings 314 and 316 may be optimized for high speed cruise flight with little compromise for stall speed and landing performance since landing is be accomplished by the vertical lift system comprising motors 310. A center module between the lift fans 310 may include the pilot/operator, a hybrid power generator, a fuel tank, a full vehicle parachute system, the necessary connections to the Pod 304, and a redundant air data sensor package. The outboard booms 318 and 320 may contain the electrical energy storage system (e.g., batteries), and provide structure to transfer loads from the lifting fans 310 to the wings 314 and 316.

Each of the lift props 310 on the flight vehicle 302 may be powered by multiple independent motors (all on the same shaft). Each motor may have its own motor controller and power monitoring sensors and is connected to an independent source of power from the Pod 304. Each motor bearing may have redundant thermocouples to monitor the bearing temperature and track the wear on the bearing through examination of heat build-up. In this way, bearing failure may be predictable and maintenance/bearing replacement can be scheduled as needed. Additionally or alternatively, nested bearing configuration may be used to further increase reliability.

The system may have redundant inertial navigation systems and radio navigation sensors (GPS). SOA sensor fusion algorithms may be used to constantly update the vehicle state and identify and ignore faulty sensors. Additionally or alternatively, long range LIDAR system may be used, for example, to identify obstacles near potential landing zones. Radar data may be fused with ADS-B signals and other data sources to identify potential nearby aircraft or birds. Additionally or alternatively, various embodiments contemplate that data may be voluntarily exchanged with other aircraft over ad-hoc V2V networks like DSRC and/or C-V2X.

The lifting props may be locked into a fore-aft blade orientation for cruise flight to minimize the drag produced by the VTOL system. The props may be optimized for low-tip speed operations (tip Mach between 0.4 and 0.6) to minimize the noise impact of VTOL operations on the communities near the vertiports. The props may be fixed pitch to minimize maintenance costs.

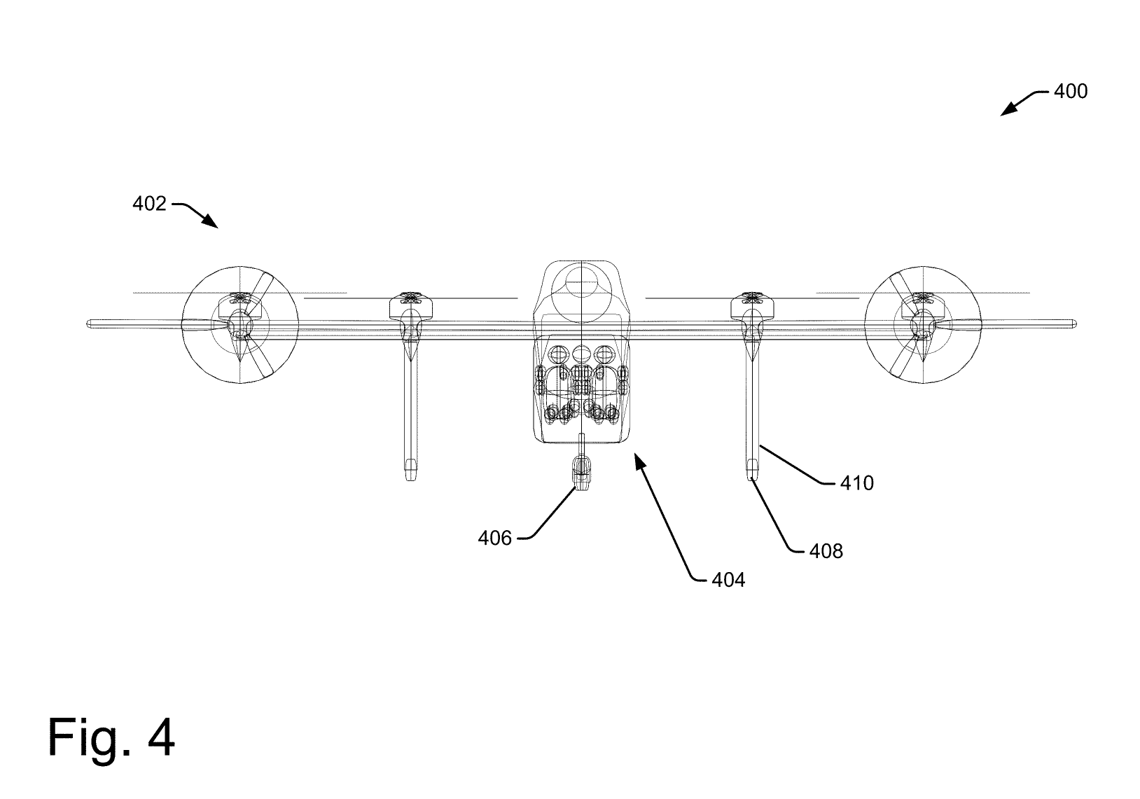

FIG. 4 shows a front view of any embodiment of a flight system 400. For example, flight system 400 may comprise flight vehicle 402 coupled to Pod 404. Additionally or alternatively, flight vehicle 402 may comprise landing gear 406 and 408 to elevate Pod 404 when the flight system 400 has landed. Additionally or alternatively, the landing gear 408 may be coupled to a vertical stabilizers 410 of flight vehicle 402. Various embodiments contemplate that vertical stabilizers 410 may be spaced sufficiently apart from each other to allow sufficient stability of the flight system 400 when landed on landing gear 408 and 406. Additionally or alternatively, the vertical stabilizers 410 may also be sufficiently spaced to allow access to the Pod 404 by a ground vehicle (not pictured).

Loads may be transferred through locating bearing surfaces capable of reacting inertial loads the vehicle may be subject to in the crash scenarios specified in FMVSS 208 and 216. The ground vehicle may have the crumple zone and energy absorbing structures. The Pod may contain a carbon fiber safety cage with pre-tensioning, load-limiting seatbelts and airbags.

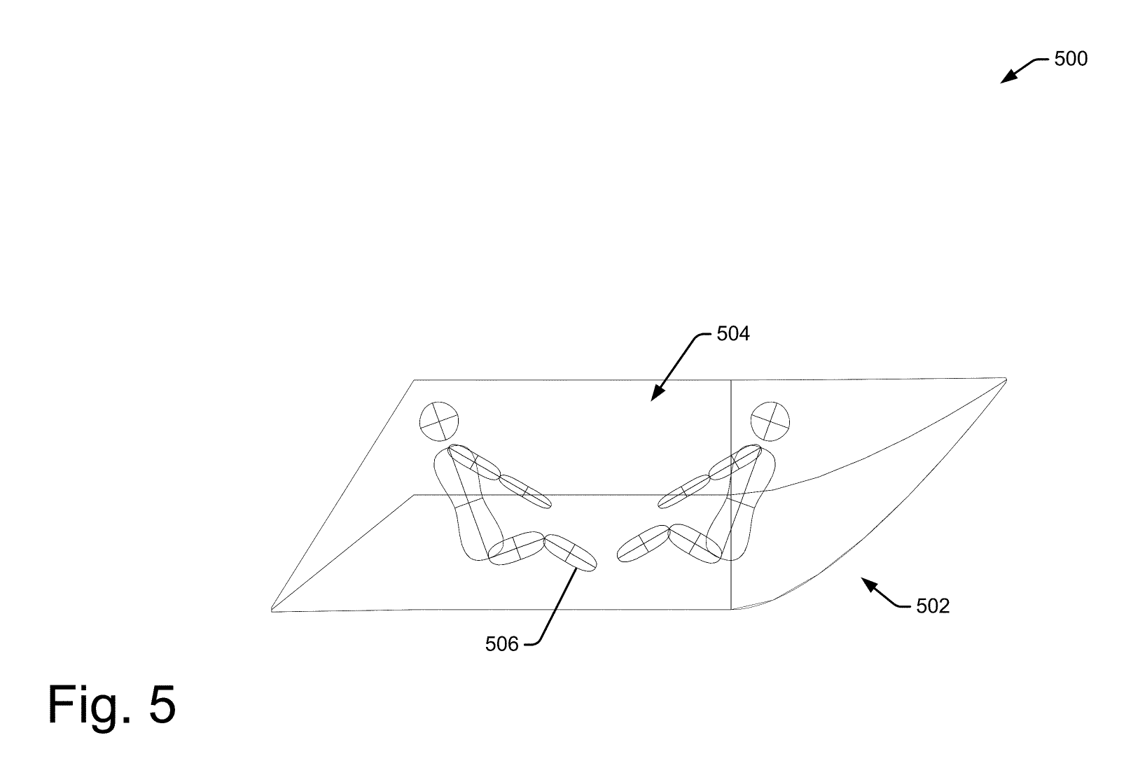

FIG. 5 shows a cutaway of an illustrative embodiment of a Pod 500. For example, Pod 500 may have a shell 502 that may comprise a desirable aerodynamic surface to reduce drag during operation of the system. Additionally, Pod 500 and optionally shell 502 may be configured and adapted to mate with both a flight vehicle and ground vehicle. Additionally or alternatively, Pod 500 may provide an internal area 504 which may be configured to securely fit passengers 506 or cargo.

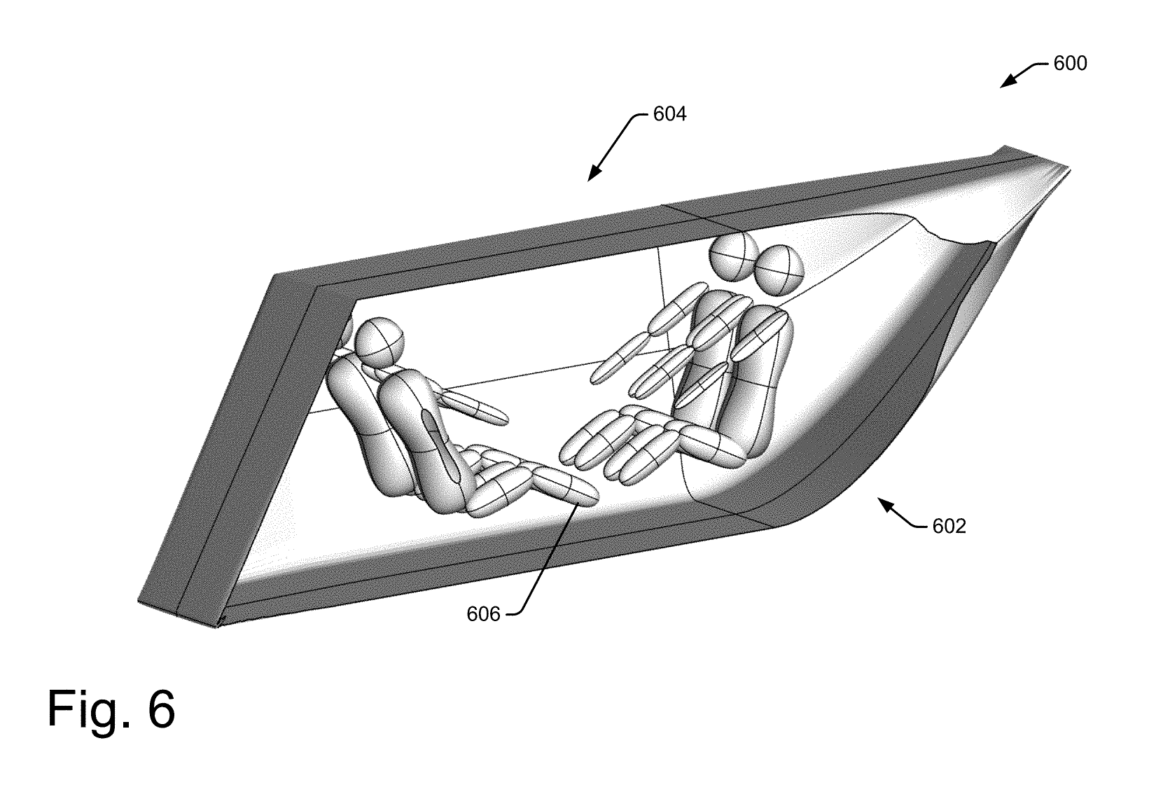

FIG. 6 shows a cutaway of a perspective view of an illustrative embodiment of a Pod 600. For example, Pod 600 may have a shell 602 that may comprise a desirable aerodynamic surface to reduce drag during operation of the system. Additionally, Pod 600 and optionally shell 602 may be configured and adapted to mate with both a flight vehicle and ground vehicle. Additionally or alternatively, Pod 600 may provide an internal area 604 which may be configured to securely fit passengers 606 or cargo.

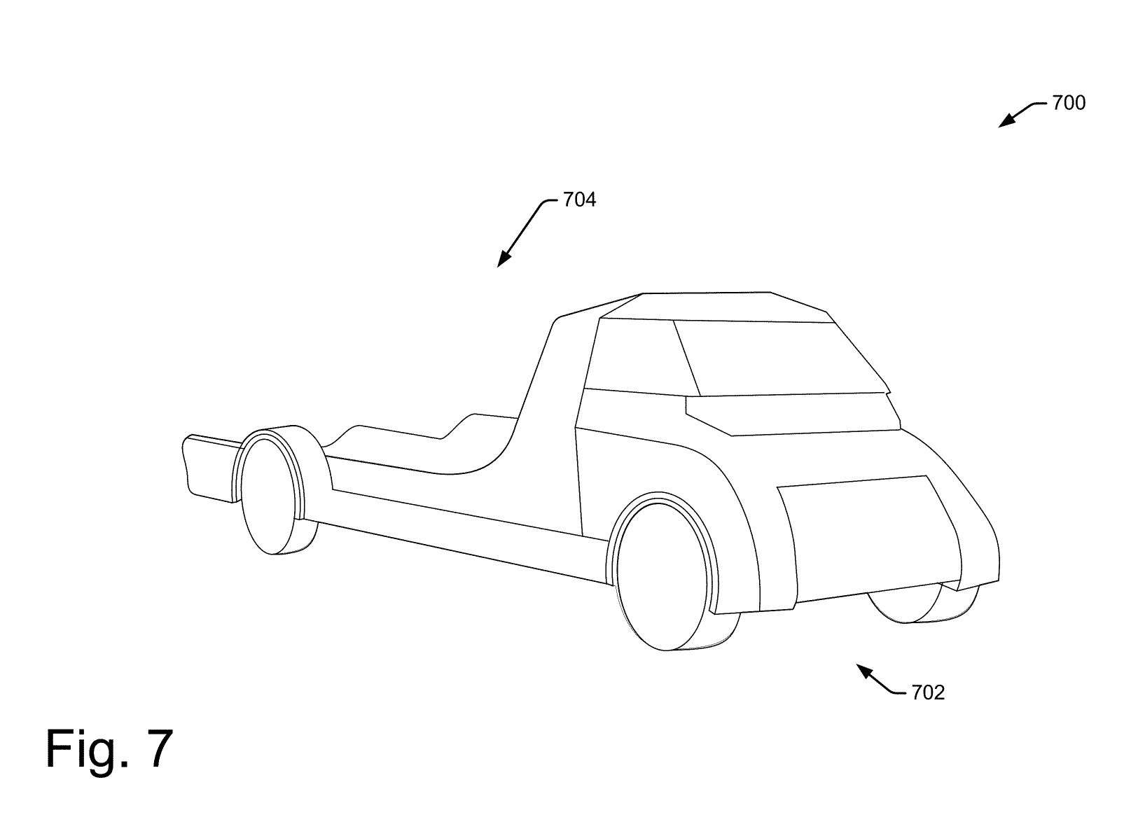

FIG. 7 shows an illustrative embodiment of a ground transportation system 700. For example, ground transportation system 700 may comprise a ground vehicle 702. Various embodiments contemplate that ground vehicle 702 may be configured to adaptively mate to a Pod (not shown) at region 704.

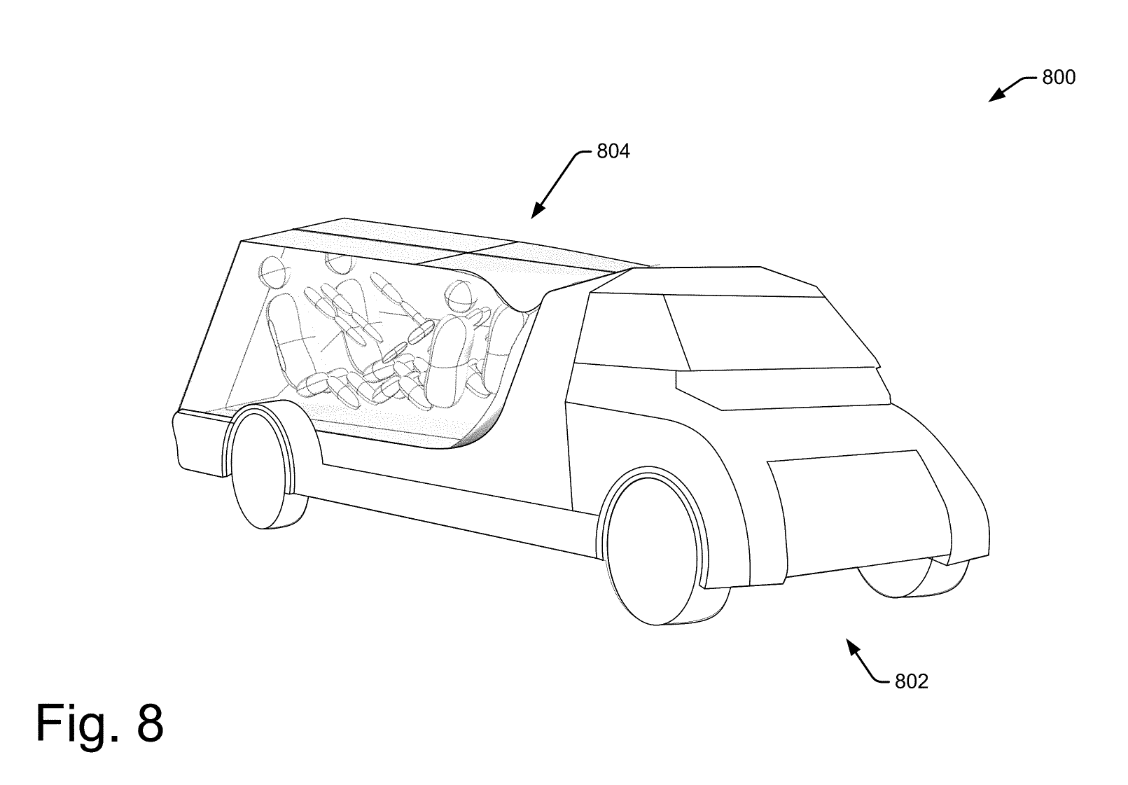

FIG. 8 shows an illustrative embodiment of a ground transportation system 800. For example, ground transportation system 800 may comprise a ground vehicle 802 and a Pod 804. Various embodiments contemplate that ground vehicle 802 may be configured to adaptively mate to the Pod 804. Additionally or alternatively, various embodiments contemplate that the ground vehicle 802 may be configured to attached and detach Pod 804 from a flight vehicle (not shown). For example, ground vehicle 802 may raise or lower a mating surface of the ground vehicle 802 to selectively engage Pod 804 when Pod 804 is still attached to a flight vehicle or to attach the Pod 804 to a flight vehicle.

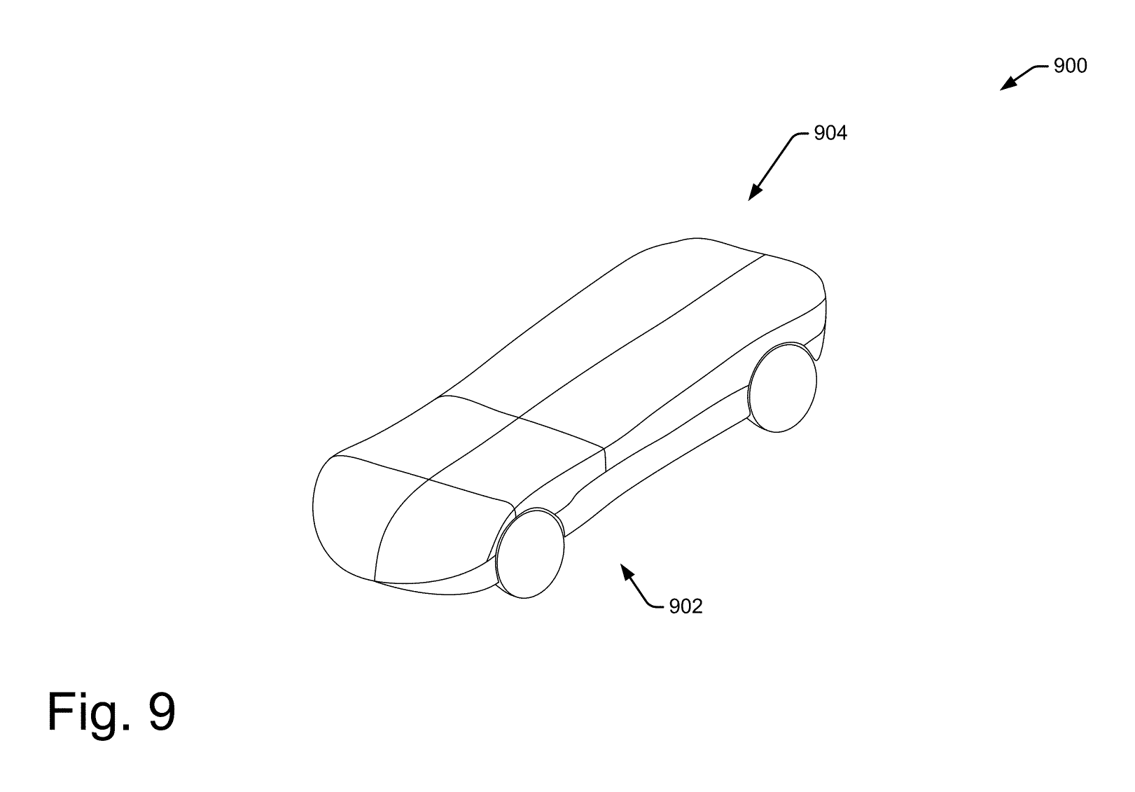

FIG. 9 shows an illustrative embodiment of a ground vehicle 900. Here, ground vehicle 900 may be configured with control system 902 sufficient to autonomously control some or all of the ground vehicle functions. Additionally, ground vehicle 900 may be configured to have a mating surface 904 configured to mate with and engage a Pod (not shown).

Both the ground vehicle and the Pod batteries may be charged via plug from a charging station.

People and cargo may be directly loaded only into the Pod. The ground vehicle and the flight vehicle may be optimized to transport the Pod on the ground and in the air respectively. These components thereby include an optimal eVTOL transportation system.

The Pod may be constantly connected to the cloud-based software system via a cell-based data link (similar to the NASA UTM system) with satellite and wifi backup. Preferably, no flight-safety-critical information is transferred over the data link. If communication is lost, the vehicle can continue to fly the flight plan, but a flight may not be initiated without a good datalink.

A vehicle operator may command a landing at the nearest safe VTOL site at any time (for instance if a passenger were to become sick). The operator may also approve all takeoffs and landings, unless the vehicle determines that it must land for safety reasons. The operator may be able to request assistance from the ground via video-chat with a human dispatch monitor on the ground.

If the vehicle ever overrides the operator and commands a landing without operator approval, an emergency may be declared (with corresponding automated announcements on 121.5 MHz, via transponder code, and EL T activation) and external sirens may sound to alert parties on the ground to the incoming landing vehicle.

The operator can also deploy the full-vehicle parachute system in the highly improbable event of a complete automated system failure.

### Illustrative Operational Environment

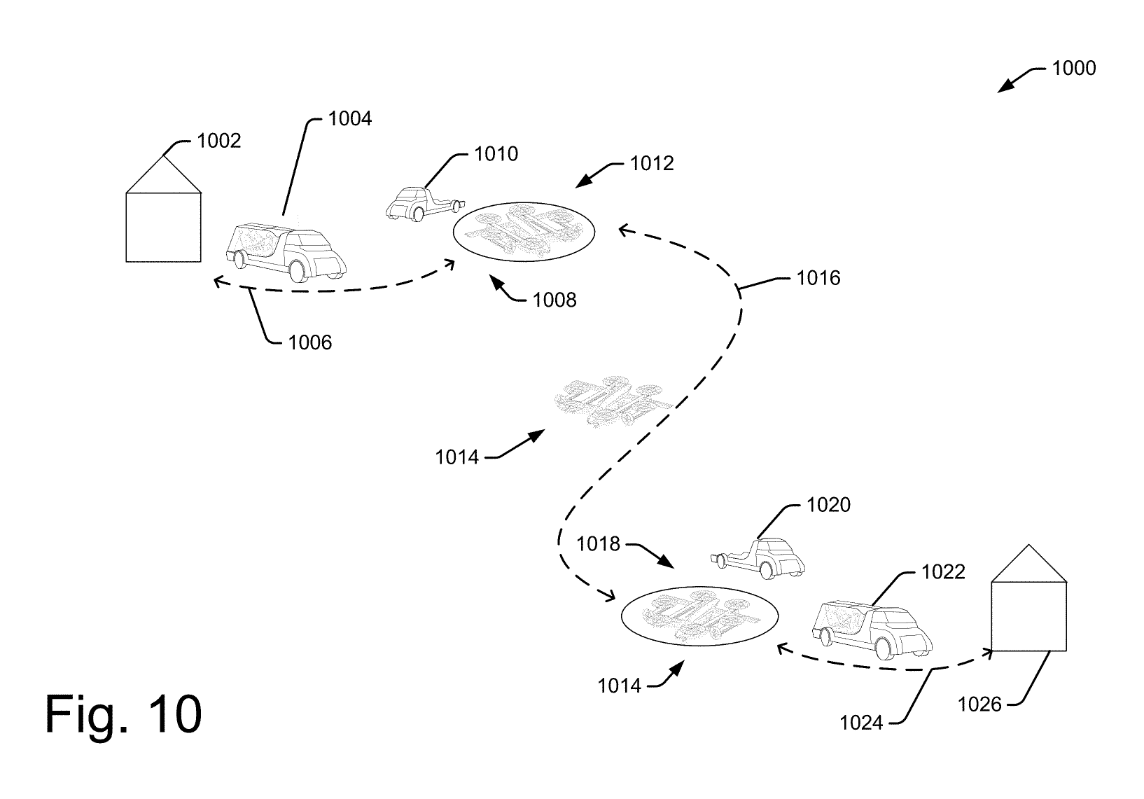

FIG. 10 shows an illustrative operational environment 1000. Here, a first location 1002 may serve as a pick up spot for cargo or passengers. Upon request or otherwise coordination, a ground transportation system 1004 comprising a ground vehicle and pod may arrive at the first location 1002 and load the desired passengers or cargo in to the pod. The ground transportation system 1004 may travel along route 1006 to a first transfer location, for example a vertiport. Here, the ground vehicle 1010 may load the pod onto a flight vehicle 1012. From here, the flight system 1014 comprising the flight vehicle 1012 and the pod may travel along route 1016 to a second transfer location 1018, for example a second vertiport. Here, flight system 1014 may land. A second ground vehicle 1020 may approach the flight system 1014 and unload the pod. Here, the second ground transportation system 1022 comprising the second ground vehicle 1020 and the pod may travel along route 1024 to reach the destination of a second location 1026 where the cargo and/or passengers may be unloaded or disembark.

### Illustrative Techniques and Methods.

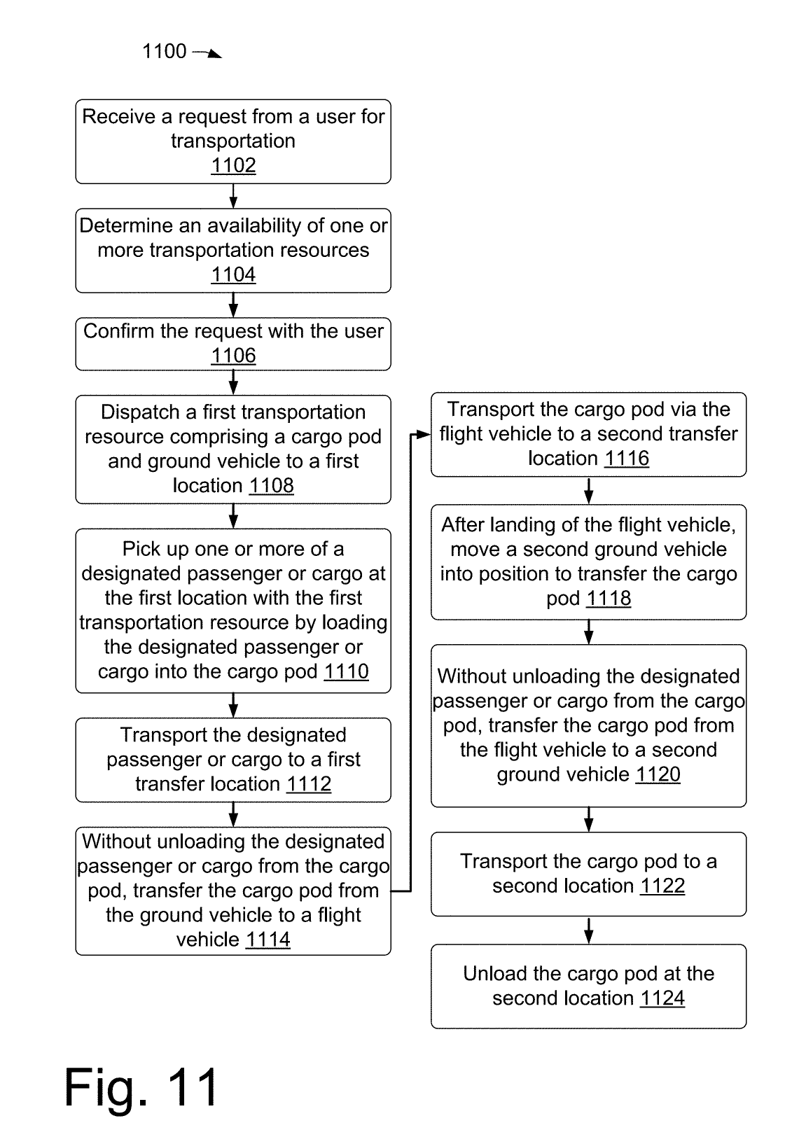

FIG. 11 shows an illustrative method 1100 of operating a transportation system. Here, the method may be operated with and in some or all of the embodiments and operational environments discussed with respect to FIGS. 1-10.

At 1102, a transportation system may receive a request from a user for transportation. For example, a user may wish to transport the user, other people, or cargo between two locations.

At 1104, the system may determine an availability of one or more transportation resources sufficient to meet the request.

At 1106, the system may confirm the request with the user.

At 1108, the system may dispatch a first transportation resource comprising a cargo pod and ground vehicle to a first location to meet the request.

At 1110, the system may pick up one or more of a designated passenger or cargo at the first location with the first transportation resource by loading the designated passenger or cargo into the cargo pod. For example, if the request included cargo or a group of people, the designated people and/or cargo may be loaded into the pod.

At 1112, the system may transport the designated passenger or cargo to a first transfer location, for example, a vertiport.

At 1114, without unloading the designated passenger or cargo from the cargo pod, the system may transfer the pod from the ground vehicle to a flight vehicle.

At 1116, the system may transport the pod via the flight vehicle to a second transfer location. For example, the second transfer location may be located geographically closer or more readily accessible by a ground vehicle than the first transfer location.

At 1118, after landing of the flight vehicle, the system may move a second ground vehicle into position to transfer the pod from the flight vehicle to the ground vehicle.

At 1120, without unloading the contents of the pod, the system may transfer the pod from the flight vehicle to the second ground vehicle.

At 1122, the system may transport the cargo pod to a second location via the second ground vehicle.

At 1124, the system may unload the pod at the second location.

### CONCLUSION

Although embodiments have been described in language specific to structural features and/or methodological acts, it is to be understood that the disclosure is not necessarily limited to the specific features or acts described. Rather, the specific features and acts are disclosed herein as illustrative forms of implementing the embodiments. Any portion of one embodiment may be used in combination with any portion of a second embodiment.

What is claimed is:

1. An integrated transportation system comprising:
a flight vehicle;
a payload pod, the payload pod configured to selectively couple to the flight vehicle using a first mating attachment; and
a ground vehicle, the payload pod further configured to selectively couple to the ground vehicle using a second mating attachment, the ground vehicle configured to selectively attach or detach the payload pod to or from the flight vehicle when the flight vehicle has landed.

2. The integrated transportation system of claim 1, wherein the payload pod further comprises a. habitable volume for people.

3. The integrated transportation system of claim 1, wherein the payload pod further comprises a volume for transportation of cargo.

4. The integrated transportation system of claim 1, wherein the ground vehicle is adapted to charge an energy storage system in the payload pod.

5. The integrated transportation system of claim 1 wherein the ground vehicle is configured to selectably attach, detach, or combinations thereof an energy storage system from the flight vehicle.

6. The integrated transportation system of claim 1 wherein the ground vehicle is configured to fuel the flight vehicle.

7. The integrated transportation system of claim 1, wherein the payload pod is adapted to be at least one of charged or fueled directly from an off-board source.

8. The integrated transportation system of claim 1, wherein the ground vehicle comprises a lift mechanism to facilitate docking of the flight vehicle, payload pod, or ground vehicle.

9. The integrated transportation system of claim 1, wherein the flight vehicle comprises at least one lift propeller having a substantially vertical rotation axis and adapted for vertical flight, and at least one separate cruise propeller having a substantially horizontal rotation axis and adapted for cruise flight.

10. The integrated transportation system of claim 1 wherein the flight vehicle comprises one or more lift propellers with a rotation axis that is substantially vertical and are optimized for vertical flight, and one or more cruise propellers with a rotation axis that is substantially horizontal and optimized for cruise flight, the one or more lift propellers being separate from the one or more cruise propellers.

11. The integrated transportation system of claim 1, wherein the ground vehicle is configured for autonomous alignment with the flight vehicle to facilitate transfer of the payload pod between the ground vehicle and the flight vehicle.

12. The integrated transportation system of claim 1, wherein control of the system on the ground and in air is substantially autonomous.

13. The integrated transportation system of claim 1, wherein controlof the system on the ground and in air is facilitated by a human operator.

14. The integrated transportation system of claim 1, wherein the flight vehicle comprises at least one sensor adapted to qualify a safe vertical takeoff and landing location.

15. The integrated transportation system of claim 1, wherein the system is adapted to, one or more of, automatically and remotely coordinate, be monitored, and be supported by a cloud-based software system to facilitate at least one of safe operations, optimal energy management, condition monitoring, maintenance scheduling, or customer pickup/drop-off routing.

16. The integrated transportation system of claim 1, further comprising a full vehicle parachute system adapted to be activated if at least one of an energy reserves of the vehicle or a failure of a flight computer prohibit a safe landing.

17. A method comprising the steps of:
determining an availability of transportation resources based at least in part on a request from a user;
dispatching a first transportation resource comprising a pod and ground vehicle to a first location;
receiving one or more of a designated passenger or cargo into the pod;
transporting the pod to a first transfer location;
without unloading contents of the pod, transferring the cargo pod from he ground vehicle to a flight vehicle;
transporting the pod via the flight vehicle to a second transfer location;
after landing of the flight vehicle, moving a second ground vehicle into position to transfer the pod to the second ground vehicle;
without unloading the pod, transferring the pod from the flight vehicle to the second ground vehicle; and
transporting the pod to a second location.
